(19) United States
(12) Patent Application Publication
(10) Pub. No.: US 2005/0098084 A1
(43) Pub. Date: May 12, 2005

(54) Flag display device

(76) Inventor: Ralph Thomas Puett III, Corona, CA (US)

Correspondence Address: Albin H. Gess;SNELL & WILMER L.L.P., Suite 1200, 1920 Main Street, Irvine, CA, 92614-7230, US

(21) Appl. No.: 10/702,842

(22) Filed: Nov. 6, 2003

(51) Int. Cl. G09F 17/00

(52) U.S. Cl. 116/173

(57) ABSTRACT

A flag display device has a handle to be grasped by a flag waver. The handle is rotatably attached to the flag at one point. The flag may be in the shape of a variety of athletic shirts. The rotatably attached handle allows easy swinging of the flag in the air with one hand.

### BACKGROUND OF THE INVENTION

1. Field of the Invention

The present invention relates generally to improvements in flag display devices and more particularly pertains to a new and improved flag waving device wherein the flag can be rotated and swung in the air.

2. Description of the Prior Art

The standard method of displaying flags and waving flags in front of audiences is by displaying the flag on poles carried by a person or displaying the flag connected to a chain that is carried or swung by people. Although chain display devices for flags are capable of being swung in the air by a person, the chain flag structure utilized tends to cause hand fatigue, in that the hand of the person is the rotating mechanism.

### SUMMARY OF THE INVENTION

A flag having a novel shape like a baseball shirt, for example, has a handle rotatably attached to a part of the flag to allow the flag to be rotatably swung in the air with one hand. A grommet in the flag acts as a bearing for a shaft that passes through the grommet and rotatably holds the flag to the handle.

### BRIEF DESCRIPTION OF THE DRAWINGS

The exact nature of this invention as well as its objects and many advantages will become readily apparent as the same becomes better understood by reference to the following detailed description when considered in conjunction with the accompanying drawings in which like reference numerals designate like parts throughout the figures thereof and wherein:

FIG. 1 is a front perspective of a preferred embodiment of the invention.

FIG. 2 is an assembly drawing of a preferred embodiment of the present invention.

FIG. 3 is a cross-sectional view of the handle mechanism shown in FIG. 1 taken along line 3-3.

FIG. 4 is a cross-sectional view of FIG. 3 taken along line 4-4.

FIG. 5 is a cross-sectional view of FIG. 3 taken along line 5-5.

### DETAILED DESCRIPTION OF THE PREFERRED EMBODIMENTS

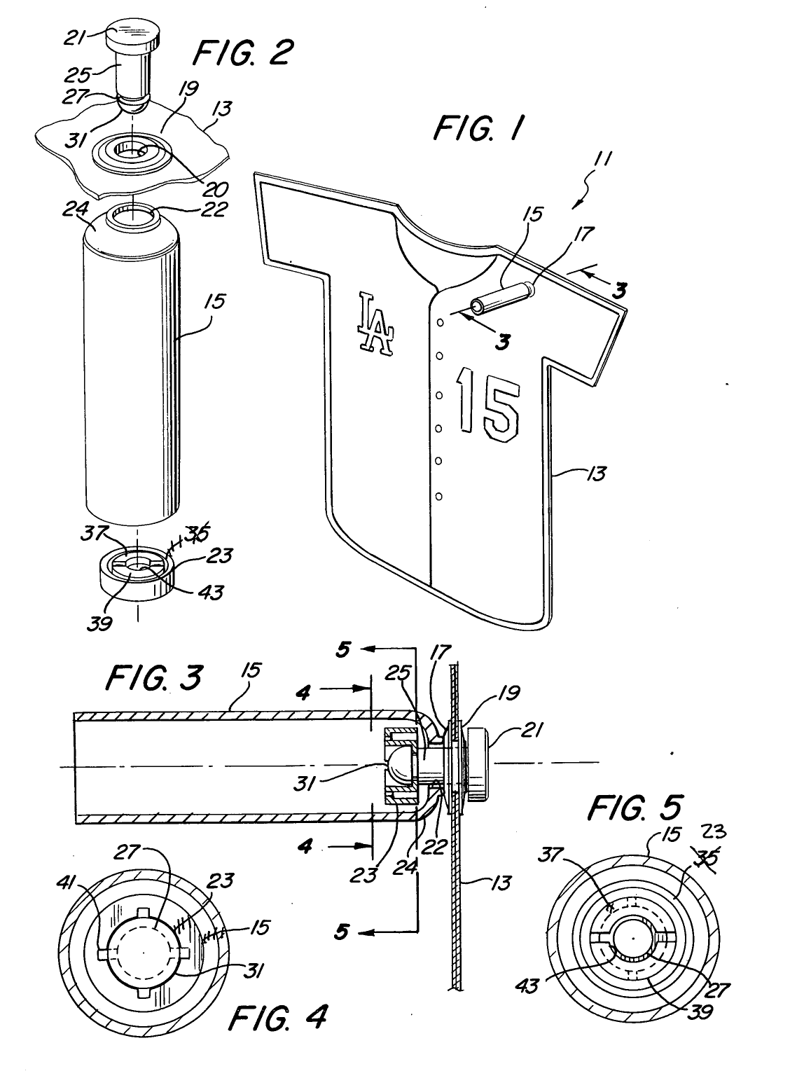

A preferred embodiment 11 of the invention is shown in FIG. 1. A flag 13, in a novel shape, of a shirt from a baseball uniform for the L.A. Dodgers, for example, is adapted to be swung in the air by the display device of the present invention which comprises a handle 15, preferably cylindrical and sufficiently long to be grasped by a hand of a person waving the flag 13. The handle 15 is rotatably attached to the flag 13 through an aperture in the flag which is lined with a grommet 17. The flag 13 is waved by simply grasping the handle 15 and swinging it in a circular motion in the air above one's head or at the side, as desired.

The handle 15 (FIG. 2) is preferably an injection molded hollow plastic cylinder. The handle 15 is attached to the flag 13 through a metal grommet having halves 17 and 19. The grommet halves act as a bearing for a shaft 25 that has a button head 21 larger in diameter than the shaft 25 at one end of the shaft. The other end of the shaft has a groove 27 circumscribing shaft 25 and a rounded end 31. The flag 13 is held by handle 15 through shaft 25 with its button head 21, and rotates above shaft 25. Shaft 25 acts as a journal within the bearing surfaces 20 of grommet halves 17 and 19. Besides rotating within the aperture 20 in grommet 17-19, shaft 25 rotates within the aperture 22 at the closed end 24 of handle 15. The shaft 25 with its button head 21 is held to handle 15 by a snap-on nut 23 which has an aperture 43 formed within two deflecting ridges 37 and 39. Ridges 37 and 39 deflect to pass over the rounded end 31 of shaft 25 and snap into the circumferential groove 27 of the shaft.

The shaft 25 and the snap-on nut 23 are preferably injection molded parts. However, it should be understood that they could just as easily be manufactured from a metal or similar material. The shaft 25 is sized to fit and rotate within aperture 20 of grommet 17-19 and aperture 22 in the closed end 24 of handle 15. In operation, flag 13 rotates about shaft 25, and shaft 25 may also rotate within the bearing aperture 22 in handle 15. The result is a very easy and free swinging flag 13. Because of the novel shape of flag 13, that is, the shape of a jersey part of an athletic uniform, like a baseball uniform, football uniform, or hockey uniform, for example, such a shape is more difficult to swing. The display device of the present invention makes it easy for the user to easily swing the flag 13 in the air.

FIG. 3 illustrates the invention in cross-section, showing flag 13 being held firmly by the two grommet halves 17 and 19. Shaft 25 extends through the aperture 20 formed by the grommet halves 17 and 19, and through the aperture bearing 22 in end 24 of handle 15. The flag 13 is held to handle 15 by shaft 25 whose movement in a lateral direction is restricted by button head 21 and the snap-on nut 23.

Nut 23 is preferably an injection molded plastic part which is designed to allow the two ridges 37 and 39 on its top side to be essentially spring loaded and thereby capable of deflecting so that it can pass over the rounded end 31 of shaft 25 and snap into the circumferential groove 27. Aperture 43 of the snap-fit nut 23 is sized to be the same diameter as the shaft within groove 27. The bottom end of nut 23 has grooves 41 therein for allowing the two ridges 37 and 39 to flex as required during assembly. After assembly, however, as a result of the structure of flex nut 23, it requires excessive force to pull the nut from shaft 25. This excessive force exceeds any force that may be applied to the nut 23 as a result of the swinging of flag 13 during normal use.

1. A flag display device for rotatably swinging the flag in the air comprising:
a flag having an aperture, the aperture being circumferentially reinforced;
a holder adapted to be grasped by one hand, the holder having an aperture at one end: and
a shaft with a button head on one end and a snap-on nut on the other end passing through the aperture in the flag and the aperture in the holder, whereby the flag is rotatable held to the holder between the button head on the shaft and the end of the holder, the snap-on nut rotatable holding the shaft to the holder.

2. The flag display device of claim 1 wherein the flag is in the shape of a shirt from an athletic uniform.

3. The flag display device of claim 1 wherein the flag is in the shape of a baseball uniform shirt.

4. The flag display device of claim 1 wherein the flag circumferentially reinforced aperture includes a grommet.

5-6. (canceled)

7. The display device of claim 4 wherein the shaft and snap-on nut are injection molded plastic parts.

8. The display device of claim 4 wherein the grommet is made of metal.
